(19) United States
(12) Patent Application Publication
(10) Pub. No.: US 2023/0049230 A1
(43) Pub. Date: Feb. 16, 2023

(54) WALK-BEHIND LAWNMOWER SPEED CONTROLS

(71) Applicant: MILWAUKEE ELECTRIC TOOL CORPORATION, Brookfield, WI (US)

(72) Inventors: Tyler L. Graham, Milwaukee, WI (US); Joshua D. Widder, Racine, WI (US); Daniel R. Ertl, Brookfield, WI (US); Benjamin F. Shaske, Pewaukee, WI (US); Christopher Shawn Bullington, Milwaukee, WI (US); Anthony J. Buxton, Wauwatosa, WI (US); John L. Whealon, West Bend, WI (US)

(21) Appl. No.: 17/884,750

(22) Filed: Aug. 10, 2022

Related U.S. Application Data
(60) Provisional application No. 63/231,690, filed on Aug. 10, 2021.

(51) Int. Cl. A01D 34/69; A01D 34/00; A01D 34/68; A01D 34/82

(52) U.S. Cl. CPC A01D 34/69; A01D 34/006; A01D 34/6806; A01D 34/824; A01D 2101/00

(57) ABSTRACT

A walk-behind lawnmower includes a mower deck, a plurality of wheels coupled to the mower deck, a drive motor configured to operate at a drive speed to drive at least one of the plurality of wheels, and a handle coupled to the mower deck. The handle includes a user interface having a variable speed control configured to be actuated an actuation percentage, and a maximum speed control including a setting corresponding to a maximum mower speed. The drive speed of the drive motor is determined using the actuation percentage of the variable speed control scaled by the setting of the maximum speed control.

### CROSS-REFERENCE TO RELATED APPLICATIONS

This application claims priority to U.S. Provisional Patent Application No. 63/231,690, filed Aug. 10, 2021, the entire contents of which are incorporated by reference.

### BACKGROUND

The present disclosure relates to a speed control system for a power tool, such as a lawnmower.

Some lawnmowers include motor driven wheels that move the lawnmower along a travel path to assist the user in pushing the lawnmower across the grass. These lawnmowers are sometimes referred to as self-propel mowers.

### SUMMARY

In one embodiment, the disclosure provides a walk-behind lawnmower includes a mower deck, a plurality of wheels coupled to the mower deck, a drive motor configured to operate at a drive speed to drive at least one of the plurality of wheels, and a handle coupled to the mower deck. The handle includes a user interface having a variable speed control configured to be actuated an actuation percentage, and a maximum speed control including a setting corresponding to a maximum mower speed. The drive speed of the drive motor is determined using the actuation percentage of the variable speed control scaled by the setting of the maximum speed control.

In another embodiment, the disclosure provides a controller for a walk-behind lawnmower. The controller includes an electrical processing unit configured to receive a maximum speed signal corresponding to a setting of a maximum speed control, to receive a variable speed signal corresponding to an actuation percentage of a variable speed control, to determine a speed control output by multiplying the setting of the maximum speed control by the actuation percentage of the variable speed control, and send a control signal to operate a drive motor to move the lawnmower at a mower speed corresponding to the speed control output.

In another embodiment, the disclosure provides a method for controlling for a walk-behind lawnmower. The method includes detecting an actuation percentage of a variable speed control, detecting a maximum speed setting of a maximum speed control, determining a speed output based on the actuation percentage and the maximum speed setting, and sending a control signal to operate a drive motor at a drive speed corresponding to the speed output.

Other aspects of the disclosure will become apparent by consideration of the detailed description and accompanying drawings.

### BRIEF DESCRIPTION OF THE DRAWINGS

FIG. 1 is a perspective view of a walk-behind lawnmower according to one embodiment.

FIG. 2 is detailed view of a handle and a user interface of the walk-behind lawnmower of FIG. 1.

FIG. 3 is a schematic view of a controller for use with the walk-behind lawnmower of FIG. 1.

FIG. 4 is a rear view of the handle and user interface of FIG. 2.

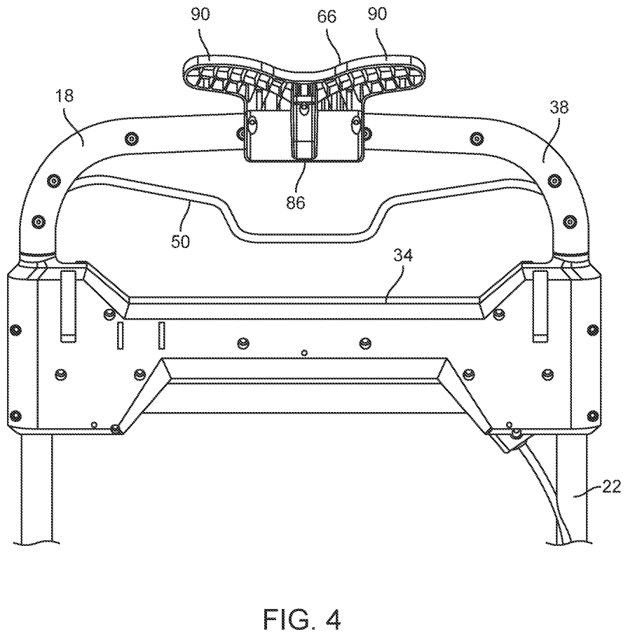

FIG. 5 is a side view of the handle and user interface of FIG. 2 with a bail in a first position.

FIG. 6 is a front view of the handle and user interface of FIG. 2 with the bail in a second position.

FIG. 7 is a top view of the handle and user interface of FIG. 2.

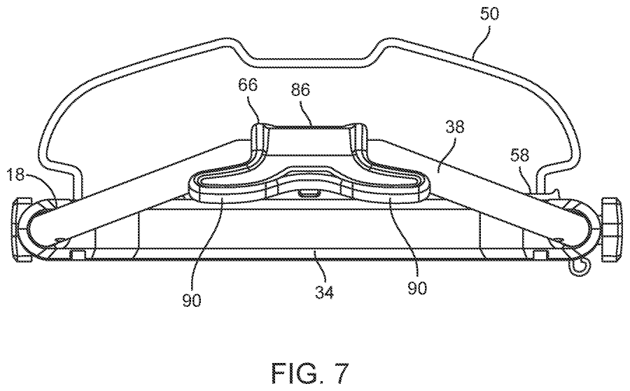

FIG. 8 is a flowchart for a speed control system for use with the walk-behind lawnmower of FIG. 1.

FIG. 9 is a schematic illustration of a state machine for a controller for use with the walk-behind lawnmower of FIG. 1.

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

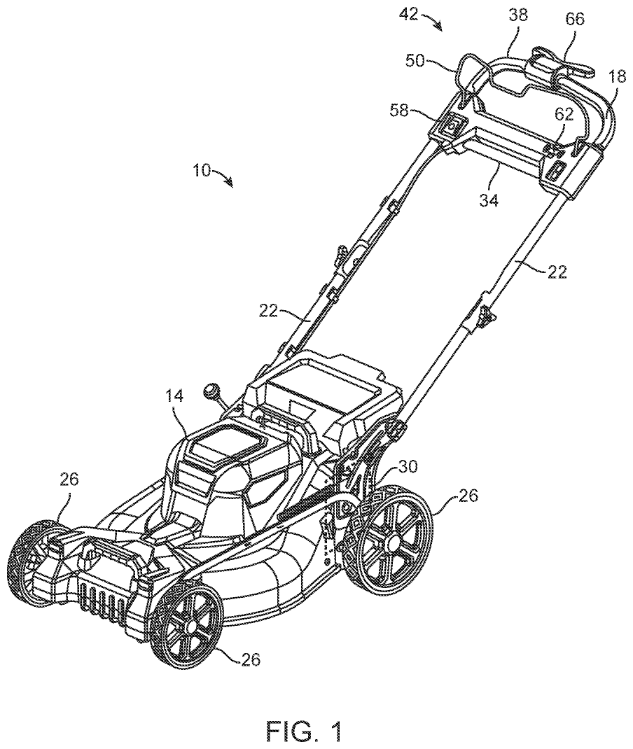

FIG. 1 illustrates a self-propelled walk-behind lawnmower 10 according to one embodiment. The illustrated lawnmower 10 may be battery-operated. The lawnmower 10 includes a mower deck 14 and a handle 18 coupled to the mower deck 14 by support beams 22. The lawnmower 10 also includes a plurality of wheels 26 coupled to the mower deck 14. The illustrated plurality of wheels 26 includes a front pair of wheels and a rear pair of wheels. The rear pair of wheels may have a larger diameter than the front pair of wheels. The plurality of wheels 26 allow the lawnmower 10 to move across a surface along a travel path.

The self-propelled lawnmower 10 includes a drive control system that may be selectively activated to assist a user in pushing the lawnmower 10 along the travel path at a mower speed. Thus, one or more of the plurality of wheels 26 may be powered wheels. Specifically, the plurality of wheels 26 may be coupled to one or more drive motors 30 that rotate the wheels 26, moving the lawnmower 10 along the travel path at the mower speed. In some embodiments, all four wheels are powered. In other embodiments, only the rear wheels are powered. In some embodiments, each powered wheel includes an associated drive motor 30. In other embodiments, a single drive motor 30 may drive multiple powered wheels.

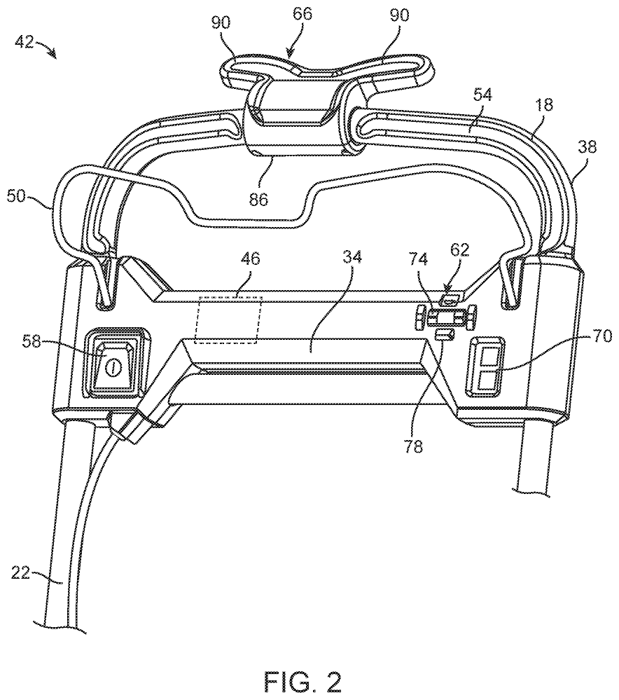

FIG. 2 illustrates a detailed view of the handle 18. The handle 18 includes a cross bar 34 and a top bar 38 extending up from the cross bar 34. The top bar 38 may serve as a grip for the user. A user interface 42 may be positioned on the handle 18 and may include some controls positioned on or adjacent the cross bar 34 and some controls located on or adjacent the top bar 38. The user interface 42 may be associated with one or both of the drive control system and a blade control system. A master control unit (MCU or controller 46) is in communication with the user interface 42 to operate the lawnmower 10. In the illustrated embodiment, the controller 46 may be located in the cross bar 34. In other embodiments, the controller 46 may be located other places in the handle 18 or in the mower deck 14.

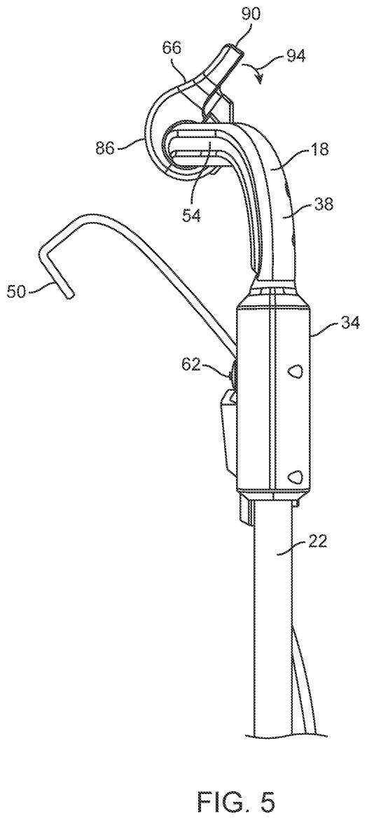

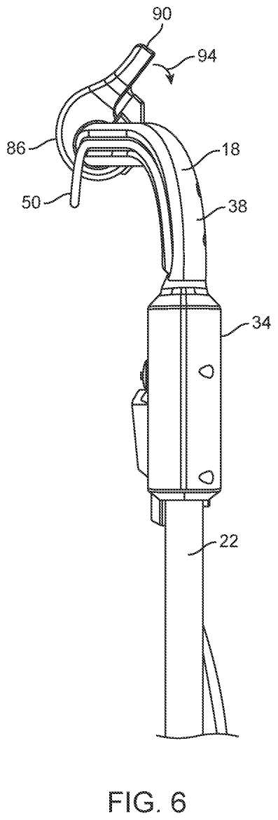

Before either the drive control system or the blade control system is activated, a bail 50 must be moved from an open position, as shown in FIGS. 2 and 5, to a closed position, as shown in FIG. 6. The handle 18 may include a recess 54 that receives the bail 50 in the second position, such that the bail 50 is flush with the outer surface of the handle 18. During operation, a user is able to position their hand around the top bar 38 to thereby maintain the bail 50 in the closed position. The bail 50 may be considered part of both the drive control system and the blade control system in some embodiments.

With reference to FIG. 2, the blade control system includes a power button 58, which may be actuated to initiate operation of the cutting blades. In the illustrated embodiment, the power button 58 is located on the cross bar 34. The illustrated drive control system is a dual speed-control system. Specifically, the drive control system includes a maximum speed control 62 (also referred to herein as a first speed control 62) to provide a maximum allowable speed of the drive wheels 26 and a variable speed control 66 (also referred to herein as a second speed control 66; e.g., a throttle) to provide adjustable speed control of the drive wheels 26. The user interface 42 may also include indicators 70 to communicate information to the user. The indicators 70 may include LEDs with associated markings or may include a display or other visual indicator. The user interface 42 may include additional controls not described in detail herein.

As best shown in FIG. 2, in the illustrated embodiment, the maximum speed control 62 may include a dial 74 positioned on the cross bar 34. The dial 74 may be mounted to the cross bar 34 to rotate about an axis. The dial 74 may be constrained to rotate between a first maximum speed position and a second maximum speed position. In the illustrated embodiment, the dial 74 is continuously adjustable between the first maximum speed position and the second maximum speed position. In other embodiments, the maximum speed control 62 may have a plurality of discrete settings. The maximum speed control 62 may include a friction component that maintains the position of the dial 74 once it has been adjusted by the user. Therefore, the maximum speed control 62 may be set before operation begins or may be changed during operation of the lawnmower 10. Markings 78 may be provided on the cross bar 34 adjacent the dial 74 to visually indicate to a user the speed mode associated with the position of the dial 74 (e.g., slow mode or LO speed mode may be associated with the first maximum speed position, and fast mode or HI speed mode may be associated with the second maximum speed position). In other embodiments, other types of actuators may be used for the maximum speed control 62. For example, the maximum speed control 62 may be realized as a lever, a knob, etc.

The variable speed control 66 may include a lever body 82 rotatably coupled to the handle 18. As shown in FIG. 2, the lever body 82 is a paddle-style lever 82 and includes a sleeve 86 extending around the top bar 38 of the handle 18, and at least one paddle 90 extending outwardly. In the illustrated embodiment, the lever body 82 is symmetrical and includes a pair of paddles 90 extending outwardly on either side of the sleeve 86. The sleeve 86 allows for rotation about the handle 18 when the paddles 90 are actuated. The variable speed control 66 is movable between a first variable speed position and a second variable speed position. As shown in FIG. 5, the lever body 82 may be pushed so that the lever body 82 rotates in a direction 94 so that the paddles 90 travel downward from the first variable speed position to the second variable speed position. The shape of the paddles 90 allows a user to actuate the variable speed control 66 from the first variable speed position toward the second variable speed position using a thumb, a palm of the hand, or the whole hand. Additionally, padding and/or texturing on the paddles 90 may facilitate single-hand actuation of the variable speed control 66. When a user is not engaging the paddles 90, a spring or other biasing member may bias the variable speed control 66 toward the first variable speed position. The paddles 90 may be within reach of a hand of the user that is gripping the top bar 38 and holding the bail 50 in the closed position. Thus, the likelihood of accidentally releasing the bail 50 while operating the variable speed control 66 is low.

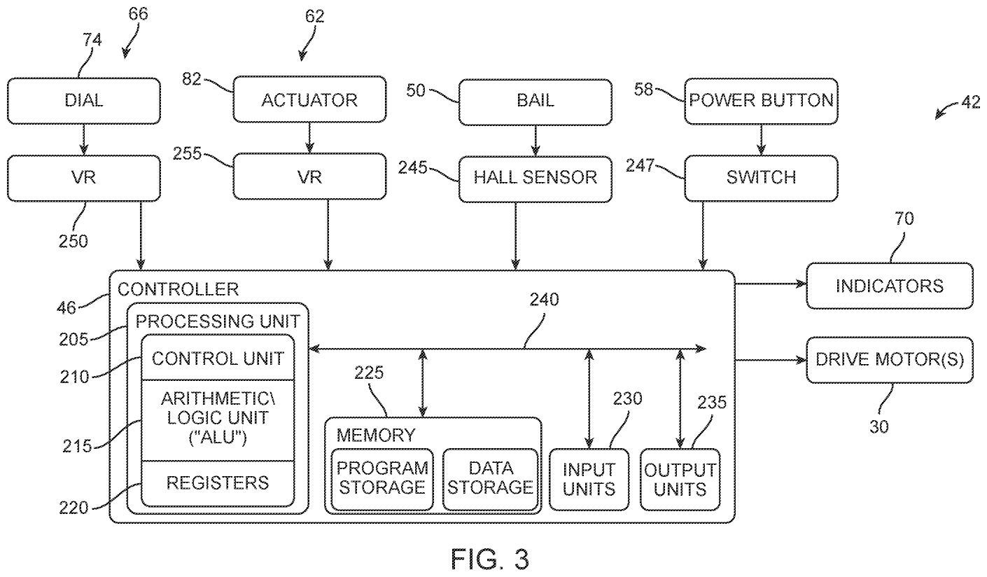

The controller 46 for the lawnmower 10 is illustrated in more detail in FIG. 3. The controller 46 is electrically and/or communicatively connected to a variety of modules or components of the lawnmower 10. For example, the controller 46 is connected to the user interface 42 including the bail 50, the maximum speed control 62, the variable speed control 66, the power button 58, and the indicators 70, as well as other additional components.

The controller 46 includes a plurality of electrical and electronic components that provide power, operational control, and protection to the components and modules within the controller 46 and/or the lawnmower 10. For example, the controller 46 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALI”) 215, and a plurality of registers 220, and is implemented using a known computer architecture (e.g., a modified Harvard architecture, a von Neumann architecture, etc.). The processing unit 205, the memory 225, the input units 230, and the output units 235, as well as the various modules connected to the controller 46 are connected by one or more control and/or data buses (e.g., common bus 240). The control and/or data buses are shown generally in FIG. 3 for illustrative purposes. The use of one or more control and/or data buses for the interconnection between and communication among the various modules and components would be known to a person skilled in the art of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instruction that are capable of being stored in a RAM of the memory 225 (e.g., during execution), a ROM of the memory 225 (e.g., on a generally permanent basis), or another non-transitory computer readable medium such as another memory or a disc. Software included in the implementation of the lawnmower 10 can be stored in the memory 225 of the controller 46. The software includes, for example, firmware, one or more applications, program data, filters, rules, one or more program modules, and other executable instructions. The controller 46 is configured to retrieve from the memory 225 and execute, among other things, instructions related to the control processes and methods described herein. In other embodiments, the controller 46 includes additional, fewer, or different components.

The controller 46 is able to activate the drive control system and the blade control system. In one embodiment, the bail 50 may include a magnet that interacts with a Hall sensor 245 positioned on the handle 18. The Hall sensor 245 may be used to determine if the bail 50 is in the first position or the second position. The bail 50 may act as an operator presence device to prevent the lawnmower 10, including the drive motor 30 and a blade motor, from operating when a user is not present and engaging the lawnmower 10. In some embodiments, the bail 50 must be held in the second position in order to maintain power to the transmission of the lawnmower 10. Releasing the bail 50 may cut off power to the transmission. In other embodiments, releasing the bail 50 may send an electrical signal to the controller 46 to limit operation of the lawnmower 10. Once the bail 50 is in the second position, a user may operate one or both of the blade control system and the drive control system.

The power button 58 for the blade control system includes a switch 247 which communicates a state of the power button 58 with the controller 46. When the power button 58 is turned on, the blade motor may be turned on, and a blade may begin to rotate.

The controller 46 receives signals from the maximum speed control 62 and the variable speed control 66 to control operation of the drive wheels 26. In the illustrated embodiment, the maximum speed control 62 may be adjusted to set a maximum allowable speed of the drive wheels 26, which sets a maximum mower speed. For example, in one embodiment, the maximum speed control 62 may be set to allow a maximum mower speed of between 1 and 4.5 mph (1.6 and 7.3 kph). In another embodiment, the maximum speed control 62 may be set to allow a maximum mower speed between 1.5 and 4 mph (2.4 and 6.5 kph).

The maximum speed control 62 may include a first variable resistor 250 (shown schematically in FIG. 3) associated with the dial 74 shown in FIG. 2. The first variable resistor 250 may be a wired component, or may be contactless (e.g., magnetic). The first variable resistor 250 may be a potentiometer or other similar component that generates a varying signal based on a position of an actuator. The first variable resistor 250 may generate a maximum speed signal (first signal) that is communicated to the controller 46. The maximum speed signal may be indicative of a setting of the maximum speed control 62. The setting may correspond to the maximum mower speed allowed by the controller 46 when the maximum speed control 62 is in the signaled position. For example, when the maximum speed control 62 is in the second position, the setting may be 4 mph (6.5 kph).

The variable speed control 66 may then be used as a variable speed adjustment within a range that is limited by the maximum allowable speed. The variable speed control 66 may also include a second variable resistor 255 (shown schematically in FIG. 3) associated with the lever body 82. The second variable resistor 255 may be a wired component, or may be contactless (e.g., magnetic). The second variable resistor 255 may generate a variable speed signal (second signal) that is communicated to the controller 46. The variable speed signal may be indicative of an actuation percentage of the variable speed control 66. The actuation percentage may correspond to a percentage of the travel distance between the first position and the second position that the lever body 82 has traveled at the time the signal is sent. For example, when the variable speed control 66 is in the first position, the actuation percentage may be zero, and when the variable speed control 66 is in the second position, the actuation percentage may be 100.

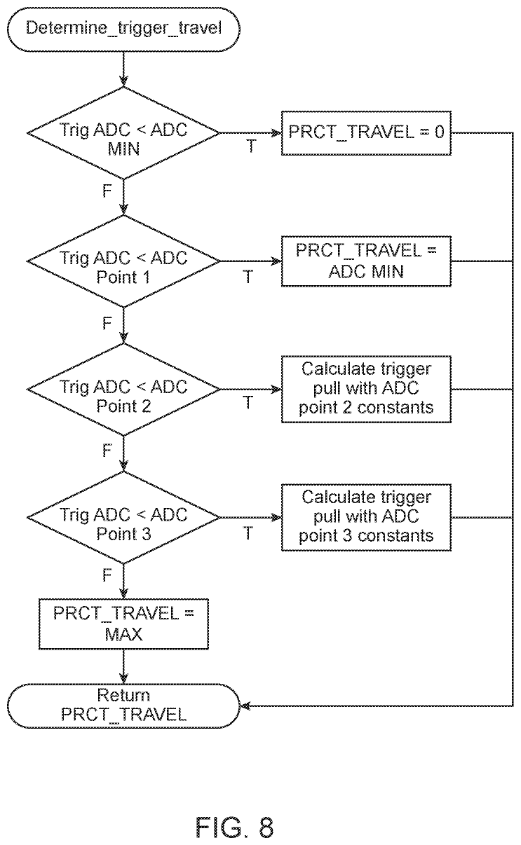

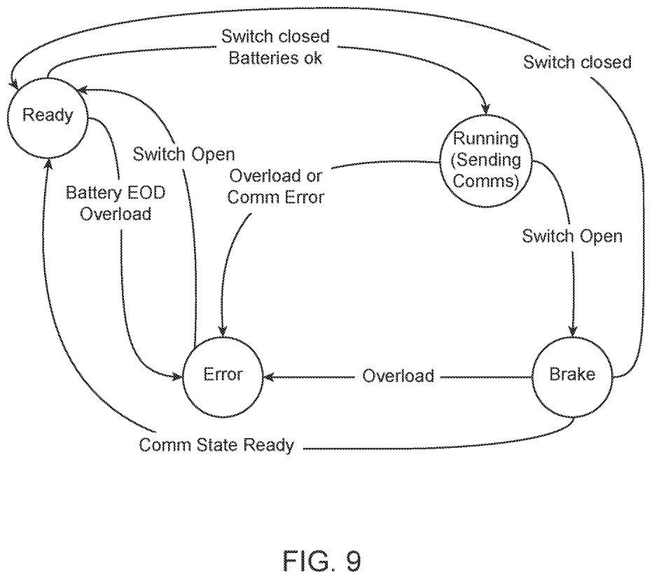

Operation of the drive control system is described with reference to FIGS. 8-9. The drive control system controls the speed of the drive motor 30 using the inputs from the maximum speed control 62 and the variable speed control 66. The drive motor speed is controlled by a maximum speed setting set by the maximum speed control 62 and the actuation percentage set by the variable speed control 66. The controller 46 receives signals from both the maximum speed control 62 and the variable speed control 66 to control the overall speed of the drive wheels 26. When a user actuates the variable speed control 66, the controller 46 determines how much the variable speed control 66 is actuated by the user. In some embodiments, the controller 46 determines the degree or the percentage of movement (e.g., rotation, slide, bend) of the variable speed control 66 relative to the total possible movement of the variable speed control 66. This may be referred to as the user input, or the “travel percentage,” or “trigger travel.”

As seen in FIG. 8, a method of determining the travel percentage of a trigger is illustrated. This method may be used to determine the actuation percentage of the variable speed control 66. Initially, the variable speed signal from the variable speed control 66 is received by a controller 46. The variable speed signal includes an adjustment duty cycle (ADC). The received ADC is serially compared to a set of stored variable speed values stored in the memory 225. For example, the received ADC may first be compared to a minimum value stored in the memory 225. If the received ADC is less than the set minimum ADC value, then the travel percentage is set as zero and stored. Otherwise, the received ADC is compared to a first value stored in the memory 225. If the received ADC is less than the first value, the travel percentage is set to the minimum value. Otherwise, the received ADC is compared to a second value. If the received ADC is less than the second value, then the controller 46 uses second constants, associated with the second value and stored in the memory 225, to calculate a travel percentage. Otherwise, the received ADC is compared to a third value. If the received ADC is less than the third value, then the controller 46 uses third constants, associated with the third value and stored in the memory 225, to calculate a travel percentage. Otherwise, the travel percentage is set to a maximum value. The travel percentage is then stored as the actuation percentage.

For the variable speed control 66, the minimum value may be zero, such that if no signal is sent, or a signal with nominal strength is sent, the actuation percentage is zero. The maximum value may be 100, such that if a high, or sufficiently strong, signal is sent, the actuation percentage is 100.

The method disclosed above and shown in FIG. 8 may also be used to determine a maximum speed setting of the maximum speed control 62. The maximum speed signal from the maximum speed control 62 is received by the controller 46 and may include an adjustment duty cycle (ADC). The received ADC is serially compared to a set of stored maximum speed values stored in the memory 225 and a travel percentage is calculated. The resulting travel percentage is stored as the maximum speed setting.

For the maximum speed control 62, the minimum and maximum values may be set to account for mechanical stack-up tolerances. Between the minimum and maximum bounds, a percent value may be calculated. In other embodiments, the first variable resistor 250 may be configured such that when the dial 74 is in the first position, the maximum speed signal is above the first value, and thus the maximum speed setting is never zero.

After calculating the actuation percentage and the maximum speed setting, the controller 46 then determines a speed control output by scaling the actuation percentage based on the maximum speed setting. In other words, the controller 46 receives the actuation percentage and determines the speed output by multiplying the actuation percentage by the maximum speed setting, as shown below:

Max Speed Percentage*Trigger Travel Percentage=Final Trigger Percentage

The speed output (or final percentage) is then translated into a drive control signal sent to the drive motor 30 to operate the drive motor 30 at a drive motor speed.

For example, if the maximum speed control 62 has a maximum speed setting of 60% (corresponding to 3 mph or ˜4.8 kph), and the variable speed control 66 is rotated 30% of its total possible rotation, the controller 46 would calculate a speed output of 18%. The controller 46 would then emit a drive control signal to the drive motors 30 to rotate at an rpm that will move the lawnmower 10 at a speed of 1 mph. In some embodiments, the final percentage may correspond to the duty cycle of the drive control signal. In other embodiments, the final percentage may be multiplied by constants stored in the memory 225 in order to determine the drive control signal.

FIG. 9 illustrates a state machine for the drive motor 30 on the controller 46. This state machine handles all motor state transitions including disengaging the transmission when the variable speed control 66 is released. The controller 46 monitors the first variable resistor 250 and the second variable resistor 255 to determine when to allow the drive motor 30 to spin. In the case that there is an error state, one of the indicators 70 may communicate the error to the user.

What is claimed is:

1. A walk-behind lawnmower comprising:
a mower deck;
a plurality of wheels coupled to the mower deck;
a drive motor configured to operate at a drive speed to drive at least one of the plurality of wheels;
a handle coupled to the mower deck, the handle including a user interface, the user interface having
a variable speed control configured to be actuated an actuation percentage, and
a maximum speed control including a setting corresponding to a maximum mower speed;
wherein the drive speed of the drive motor is determined using the actuation percentage of the variable speed control scaled by the setting of the maximum speed control.

2. The walk-behind lawnmower according to claim 1, wherein the variable speed control includes an actuator rotatably mounted to the handle.

3. The walk-behind lawnmower according to claim 2, wherein the actuator includes a pair of paddles, wherein each paddle includes a surface configured to be pushed to rotate the actuator.

4. The walk-behind lawnmower according to claim 1, wherein the variable speed control is movable between a first variable speed position, in which the actuation percentage of the variable speed control is 0, and a second variable speed position, in which the actuation percentage of the variable speed control is 100.

5. The walk-behind lawnmower according to claim 4, wherein the variable speed control is biased toward the first variable speed position.

6. The walk-behind lawnmower according to claim 1, wherein the maximum speed control is a dial coupled to the handle, wherein the dial is movable between a first maximum speed position and a second maximum speed position.

7. The walk-behind lawnmower according to claim 1, wherein the maximum mower speed is between 1.6 KPH and 7.3 KPH.

8. The walk-behind lawnmower according to claim 7, wherein the setting of the maximum speed control is between 2.4 KPH and 6.5 KPH.

9. The walk-behind lawnmower according to claim 1, wherein the user interface further includes a bail coupled to the handle for movement between an open position, in which the drive motor is prevented from operating, and a closed position.

10. The walk-behind lawnmower according to claim 1, wherein the maximum speed control includes a first variable resistor, and wherein the variable speed control includes a second variable resistor.

11. A controller for a walk-behind lawnmower, the controller comprising:
an electrical processing unit configured to
receive a maximum speed signal corresponding to a setting of a maximum speed control;
receive a variable speed signal corresponding to an actuation percentage of a variable speed control;
determine a speed control output by multiplying the setting of the maximum speed control by the actuation percentage of the variable speed control; and
send a control signal to operate a drive motor to move the lawnmower at a mower speed corresponding to the speed control output.

12. The controller according to claim 11, wherein the electrical processing unit is further configured to prevent the drive motor from operating when a bail is in an open position.

13. The controller according to claim 11, wherein the actuation percentage is a travel percentage of the variable speed control, and the actuation percentage is between 0 and 100.

14. The controller according to claim 11, wherein the setting of the maximum speed control is a travel percentage of the maximum speed control corresponding to a maximum allowable mower speed, and wherein the maximum allowable mower speed is between 2.4 KPH and 6.5 KPH.

15. The controller according to claim 11, wherein the speed control output is a final percentage, and wherein the control signal has a duty cycle corresponding to the final percentage.

16. A method of controlling a walk-behind lawnmower, the method comprising:
detecting an actuation percentage of a variable speed control;
detecting a maximum speed setting of a maximum speed control;
determining a speed output based on the actuation percentage and the maximum speed setting; and
sending a control signal to operate a drive motor at a drive speed corresponding to the speed output.

17. The method of claim 16, wherein detecting the maximum speed setting of the maximum speed control includes:
receiving a maximum speed signal;
comparing the maximum speed signal to a set of stored maximum speed signal values;
calculating a travel percentage of the maximum speed control; and
storing the travel percentage of the maximum speed control as the maximum speed setting.

18. The method of claim 17, wherein detecting the actuation percentage of the variable speed control includes:
receiving a variable speed signal;
comparing the variable speed signal to a set of stored variable speed signal values;
calculating a travel percentage of the variable speed control; and
storing the travel percentage of the variable speed control as the actuation percentage.

19. The method of claim 18, wherein determining the speed output includes multiplying the actuation percentage by the maximum speed setting to result in a final percentage, and wherein the control signal includes a duty cycle corresponding to the final percentage.

20. The method of claim 16, further comprising:
detecting a position of a bail using a Hall sensor; and
selectively sending a signal to limit operation of the drive motor based on the bail being in a closed position.
